(19) United States
(12) Patent Application Publication
(10) Pub. No.: US 2015/0309762 A1
(43) Pub. Date: Oct. 29, 2015

(54) CONTENT RENDERING DEVICE

(71) Applicant: Tom Augustine, Powell, OH (US)

(72) Inventor: Tom Augustine, Powell, OH (US)

(73) Assignee: STWRAP, LLC, Powell, OH (US)

(21) Appl. No.: 14/752,158

(22) Filed: Jun. 26, 2015

Related U.S. Application Data
(63) Continuation-in-part of application No. 14/519,514, filed on Oct. 21, 2014.
Application No. 14/519,514 is a continuation of application No. 13/761,887, filed on Feb. 7, 2013, now Pat. No. 8,898,943.
(60) Provisional application No. 61/596,939, filed on Feb. 9, 2012.
(60) Provisional application No. 62/023,441, filed on Jul. 11, 2014.
(60) Provisional application No. 61/677,237, filed on Jul. 30, 2012.

(51) Int. Cl. G06F 3/147

(52) U.S. Cl. CPC G06F 3/147

(57) ABSTRACT

A display device for presenting content that includes a housing having an opening defined in a front portion, a display disposed in the opening and that presents content and/or content items, a mounting device disposed on a rear surface of the housing, a system for presenting content disposed inside the housing, and an attachment assembly that attaches to the mounting device and to an object for the purpose of displaying the content.

### CROSS-REFERENCE TO RELATED APPLICATIONS

This application is a continuation-in-part of U.S. patent application Ser. No. 14/519,514 filed on Oct. 21, 2014 entitled “IMAGE DISPLAY DEVICE”, which is a continuation of U.S. patent application Ser. No. 13/761,887, now U.S. Pat. No. 8,898,943, filed on Feb. 7, 2013 entitled “IMAGE DISPLAY DEVICE”, which claims the benefit of U.S. Provisional Patent Application Ser. No. 61/596,939 entitled “IMAGE DISPLAY DEVICE” filed on Feb. 9, 2012 and to U.S. Provisional Patent Application Ser. No. 61/677,237 entitled “IMAGE DISPLAY DEVICE” filed on Jul. 30, 2012, and this application also claims the benefit of U.S. Provisional Patent Application Ser. No. 62/023,441 filed on Jul. 11, 2014 entitled “IMAGE DISPLAY DEVICE.” The entireties of the above-noted applications are herein incorporated by reference.

### ORIGIN

The innovation disclosed herein relates to a display device and more specifically to an attachable display device that promotes brand awareness and allegiance.

### BACKGROUND

More and more people (adults and children) wear awareness bracelets (wristbands), necklaces, etc. These awareness items can display one's allegiance to a company, a cause, a charity, a business, a sports team, an individual, a character, a movie, a product or service, a destination, etc. Essentially, the awareness item can display an allegiance to just about anything.

Specifically, awareness items can promote brand awareness for businesses, which can result in higher sales of not only one product, but on other products associated with that brand. A brand can take many forms, including a name, product/service, logo, symbol, slogan, color, etc.

Awareness items can also promote awareness to a cause typically referred to as a concept brand. One of the most notable concept brands is breast cancer awareness, which uses a pink ribbon as a symbol to raise awareness of breast cancer and educate people about its symptoms and treatment options.

### SUMMARY

The following presents a simplified summary in order to provide a basic understanding of some aspects of the innovation. This summary is not an extensive overview of the innovation. It is not intended to identify key/critical elements or to delineate the scope of the innovation. Its sole purpose is to present some concepts of the innovation in a simplified form as a prelude to the more detailed description that is presented later.

In one aspect of the innovation, an attachable display device that promotes brand awareness is provided. The device includes a display part having a display area to display an image and a securing portion, and a mounting part having an upper portion operatively connected to the display part and a lower portion having at least one hole defined therein. In one aspect, the mounting part wraps around an object such that the securing portion engages the at least one hole to secure the display device to the object. As disclosed herein, the innovation facilitates presentation of allegiance on a strap, backpack, laptop/tablet bag, duffle bag, gym bag, sport equipment bag, golf bag, purse, beach bags etc. This allegiance is to be understood as a feature and benefit of the innovation described herein.

In another aspect of the innovation an image display device is provided and includes a display area to display an image, a removable-transparent cover to facilitate the replacement of the image, a securing portion operatively connected to the display area; and a mounting part operatively connected to the display area and having at least one hole defined therein, wherein the mounting part wraps around an object such that the securing portion engages the at least one hole to secure the image display device to the object.

In another aspect of the innovation, a method of displaying an image is provided and includes providing a display device having a display part and a mounting part, wrapping the mounting part around an object, and engaging a securing portion of the display part with a hole defined in the mounting part.

In another aspect of the innovation, one or more embodiments of techniques or systems for promoting one or more images on a display device are provided herein. A display device may include a storage component which may store or include one or more customizable images for the display device to display. In one or more embodiments, a system for displaying images may be able to cycle through one or more different images (e.g., images stored on the storage component). Images may be loaded on the storage component via a communication component (e.g., via USB or universal serial bus). The system may include a power supply, such as a battery which enables the display component or display device to be portable. Additionally, the system may include a mounting component which may be a wristband around which the device or system may be worn. Other examples of mounting contemplated may include pins, fasteners, straps, magnet mounts, suction cups, etc.

In still another aspect of the innovation, a system for presenting content is disclosed that includes a display component that displays content and/or content items, an application component that manages the content and/or content items displayed by the display component, a storage component that stores the content and the content items, a communication component that enables connectivity to one or more external devices to upload/download the content and content items to/from the storage component, and a power supply providing power to the system for displaying images.

In still another aspect of the innovation, a display device for presenting content is disclosed that includes a housing having an opening defined in a front portion, a display disposed in the opening and that presents content and/or content items, a mounting device disposed on a rear surface of the housing, a system for presenting content disposed inside the housing, and an attachment assembly that attaches to the mounting device and to an object for the purpose of displaying the content.

To accomplish the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIGS. 1 and 2 are front and rear view illustrations respectively of example embodiments of a display device displaying an image in accordance with aspects of the innovation.

FIG. 3 is a perspective view of an example embodiment of a display device in accordance with aspects of the innovation.

FIG. 4 is a perspective view of the example display device of FIG. 3 with a display part in an open state in accordance with aspects of the innovation.

FIG. 5 is a front view of the example display device of FIG. 3 in accordance with aspects of the innovation.

FIG. 6 is a rear perspective view of the example display device of FIG. 3 in accordance with aspects of the innovation.

FIG. 7 is a side view of the example display device of FIG. 3 in accordance with aspects of the innovation.

FIG. 8 is a perspective view of another example embodiment of a display device in accordance with aspects of the innovation.

FIG. 9 is a perspective view of the example display device of FIG. 8 with a display part in an open state in accordance with aspects of the innovation.

FIG. 10 is a front view of the example display device of FIG. 8 in accordance with aspects of the innovation.

FIG. 11 is a rear perspective view of the example display device of FIG. 8 in accordance with aspects of the innovation.

FIG. 12 is a side view of the example display device of FIG. 8 in accordance with aspects of the innovation.

FIGS. 13A-13F are illustrations of another example embodiment of a display device displaying an image in accordance with aspects of the innovation.

FIGS. 14A-14B are illustrations of other example embodiments of a display device in accordance with aspects of the innovation.

FIG. 15A-15C illustrates a method of displaying an awareness item in accordance with aspects of the innovation.

FIG. 16 is a perspective view of an example embodiment of a display device incorporating a removable cover in accordance with an aspect of the innovation.

FIG. 17 is a close-up bottom perspective view of the example display device of FIG. 16 incorporating the removable cover in accordance with an aspect of the innovation.

FIG. 18 is a cross-section perspective view of the example display device of FIG. 16 incorporating the removable cover in accordance with an aspect of the innovation.

FIG. 19 is a close-up view of the removable cover illustrating a tab in accordance with an aspect of the innovation.

FIG. 20 is an illustration of another example embodiment of a display device incorporating a removable-magnetic cover in accordance with an aspect of the innovation.

FIGS. 21A-21B are illustrations of another embodiment of a display device in accordance with an aspect of the innovation.

FIGS. 22A-22C are illustrations of another embodiment of a display device in accordance with an aspect of the innovation.

FIGS. 23A-23B are illustrations of another embodiment of a display device in accordance with an aspect of the innovation.

FIG. 24 is a front view of an image display device for presenting content in accordance with an aspect of the innovation.

FIG. 25 is a rear view of the image display device for presenting content in accordance with an aspect of the innovation.

FIG. 26 is a side view of the image display device for presenting content in accordance with an aspect of the innovation.

FIG. 27 is an illustration of an example system for presenting content in accordance with an aspect of the innovation.

FIGS. 28-31 are several example embodiments of attachment assemblies in accordance with an aspect of the innovation.

FIG. 32 is an illustration of an example flow diagram of a method for presenting content, according to one or more embodiments.

FIG. 33 is an illustration of an example computer-readable medium or computer-readable device including processor-executable instructions configured to embody one or more of the provisions set forth herein, according to one or more embodiments.

FIG. 34 is an illustration of an example computing environment where one or more of the provisions set forth herein are implemented, according to one or more embodiments.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

While specific characteristics are described herein (e.g., thickness), it is to be understood that the features, functions and benefits of the innovation can employ characteristics that vary from those described herein. These alternatives are to be included within the scope of the innovation and claims appended hereto.

While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

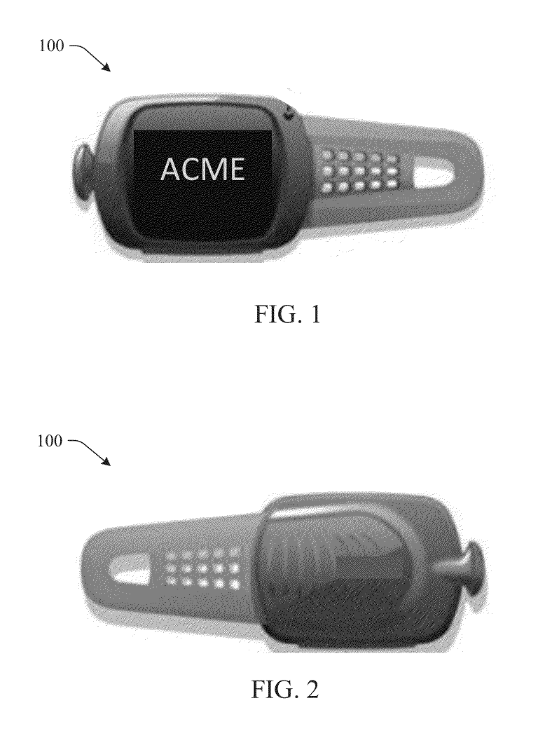

With reference now to the figures, FIGS. 1 and 2 are example embodiments of an attachable device 100 and 200 respectively, details of which will be described further below, that can be used as an awareness item to display an image, such as but not limited to, a brand name, a promotion/campaign, a logo, an individual, mascot, an allegiance, a school name, a team name, a character (e.g., cartoon, television, etc.), an ID or name tag, a locket to hold a picture, a company, a product, a service, a cause, an activity, a destination/stadium, a person, an actor/actress, an artist, an athlete, a singer, a movie/TV show, a slogan, etc. in accordance with aspects of the innovation. For example, as mentioned above, awareness items can be used to promote corporate brand awareness for businesses (see FIG. 1). The brand can take many forms, including a name, sign, symbol, product, service, slogan, color, etc. or a combination thereof. Thus, the innovation provides a means to openly display any type of image, such as a brand image associated with a corporation (e.g., ACME), or a corporation's products, services, campaigns or people. In yet another application, the attachable device can be a collector's item. For example, one could collect a series or a group (e.g., all the teams of a particular sport or the like). Thus, the attachable device can be a collectable and/or used for bargaining for trading.

Still further, the attachable device can be used as a badge to represent an accomplishment. For example, amusement and theme parks may have an attraction badge where once a person attends an attraction (e.g., rides a ride, attends a show, etc.) the person would receive a badge to show that that person conquered that attraction. The badge (attachable device) can be attached to a lanyard or the like so the person can display their accomplishments. In another example the accomplishment may be achieving high grades in school, performing community service, athletic achievements, etc. Thus, it is to be understood that the attachable device has many applications that are not disclosed herein.

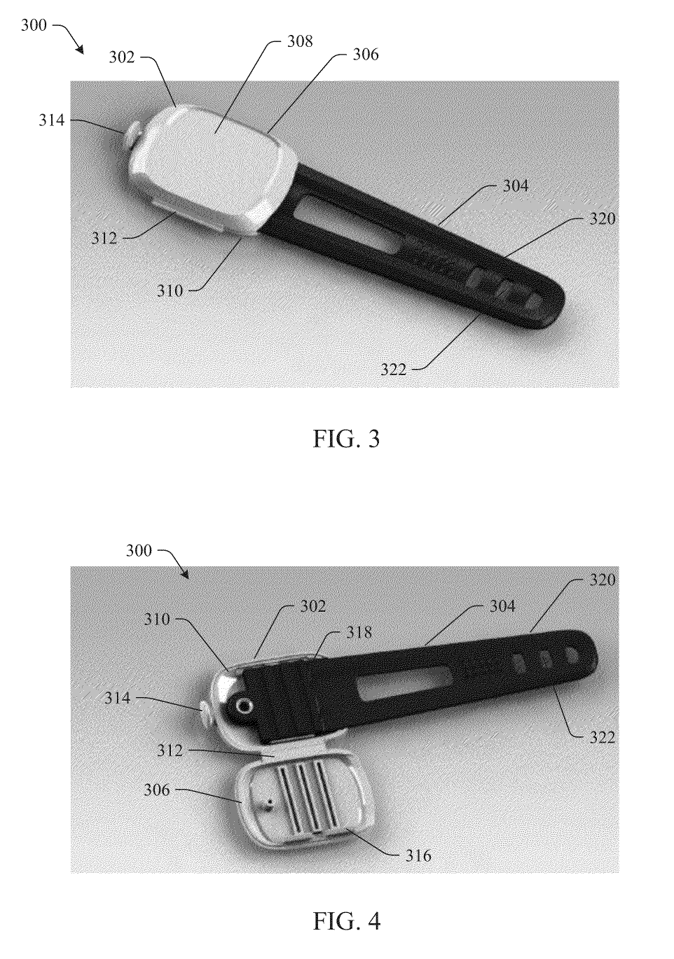

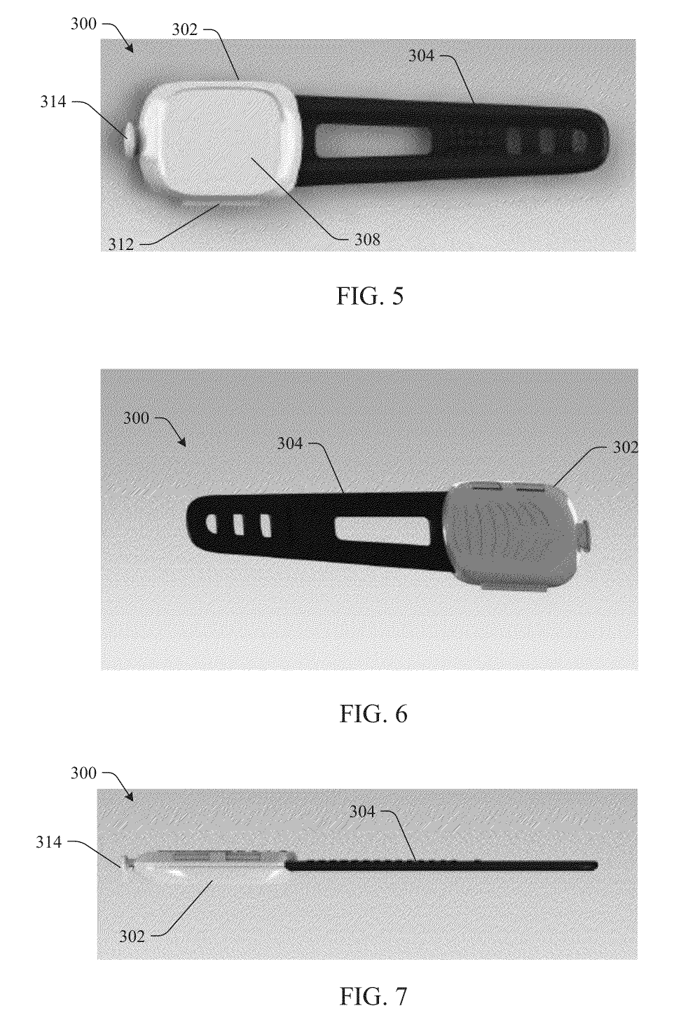

FIGS. 3-7 illustrate an example embodiment of an attachable device 300 that can be used as an awareness item that can be attached to a strap on most any object (e.g. briefcase, purse, backpack, tote bag, laptop bag, duffle bag, messenger bag, beach bag, golf bag, lunch bag, equipment bag, camera bag, suitcase, lanyards, etc.) in accordance with aspects of the innovation. The attachable device 300 can also be used as a holder to hold objects, such as but not limited to, pens, pencils, a shirt, head phones, power cords for electronic devices, etc. The attachable device 300 includes a display part 302 and a mounting part 304. The display part 302 receives a portion of the mounting part 304, as illustrated in the figures.

The display part 302 includes a first (front) portion 306 having a display area 308, a second (back) portion 310, a connecting portion 312 pivotally connecting the first portion 306 and the second portion 310, a securing portion (projection) 314, and a latching portion 316. The display area 308 is where the image is displayed, as shown in FIGS. 1 and 2. Although the shape of the display area 308 shown in the figures is rectangular, the shape of the display area 308 may be any shape, such as but not limited to, circular, square, triangular or any polygonal shape.

In one embodiment, display part can be manufactured with the image as part of the display area 308, as shown in FIGS. 1 and 2. In other embodiments, the image can be applied to the display area 308 after manufacture of the display part 302 with an adhesive, a magnet (described further below), or the image can be self-sticking, such as a sticker. In still yet other aspects, a pad print, decal, silk screen, a dome (transparent or non-transparent) with a digital print attached or the like can be employed. The dome can be made from any material, such as but not limited to urethane.

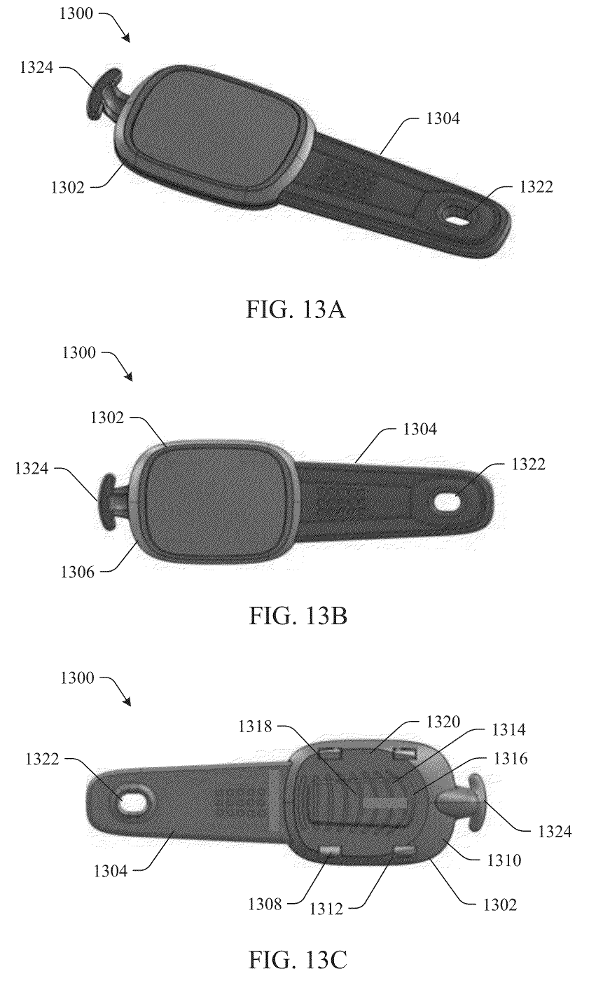

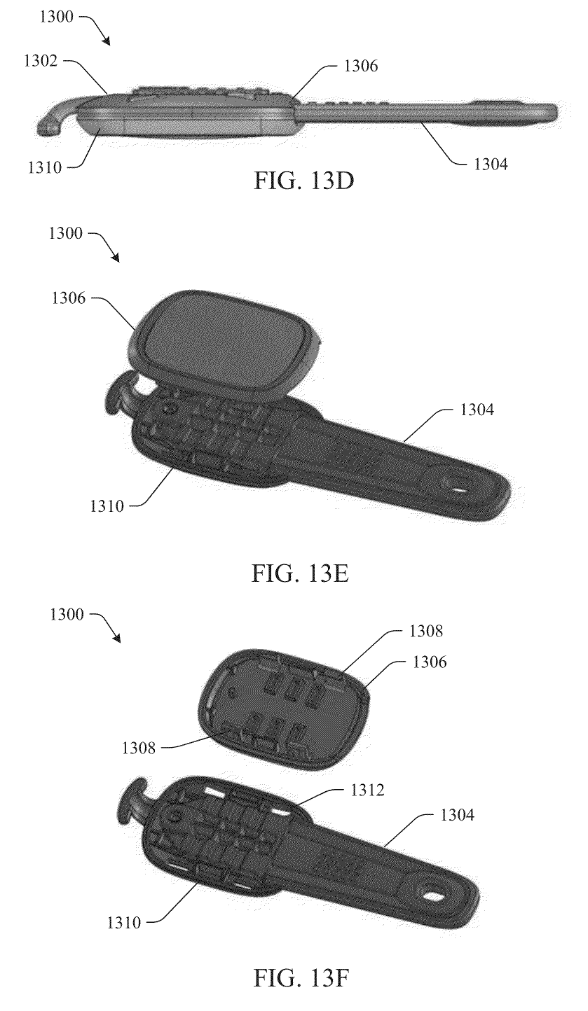

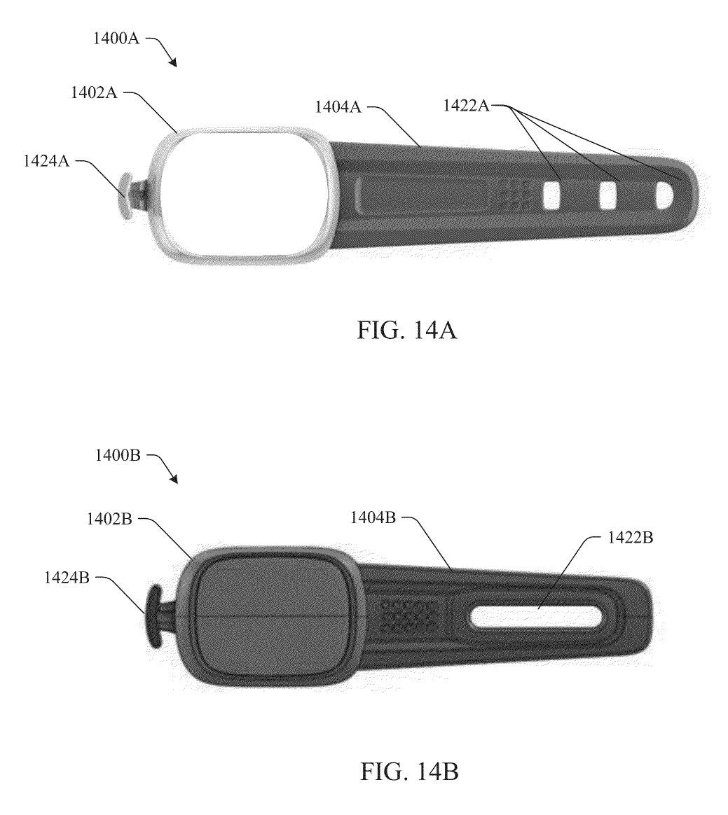

In one example embodiment (shown in FIG. 4), the display part 302 can be an integrated piece made from any suitable material, such as but not limited to, polyethylene, polypropylene, Acrylonitrile Butadiene Styrene (ABS), PA66 Nylon, etc. The connecting portion 312 is an integrated part of the display part 302 and flexes to allow the display part 302 to pivotally open and close. Thus, the connecting portion 312 is made from the same material as the display part 302 and in an example embodiment functions as a living hinge. Thus, the display part 302 can be opened and closed as many times as desired. The latching portion 316 latches the first portion 306 to the second portion 310 when the display part 302 is in the closed state, as shown in FIG. 3. It is to be understood that alternative aspects can employ a snap-together assembly, as described below in reference to FIGS. 13 and 14. Further, a single (e.g., molded) aspect can be employed to facilitate the features, functions and benefits of the innovation. In yet another example, an image (e.g., allegiance artwork or the like) can be displayed upon a single piece (e.g., soft band). These alternative examples are to be included within the scope of the innovation and claims appended hereto.

Still referring to FIGS. 3-7, the mounting part 304, which serves as a strap, can be made from a suitable elastic material, such as but not limited to rubber, plastic, Styrene ethylene butadiene styrene (SEBS), tpe plastic, silicon, leather, etc., that allows the mounting part 304 to stretch when the display device 300 is used as intended. The mounting part 304 is an integrated piece that includes a first (upper) portion 318 disposed and secured inside the display part 302 and a second (lower) portion 320. Multiple holes 322 are defined in the lower portion 320 of the mounting part 304 to attach the lower portion 320 of the mounting part 304 to the securing portion 314 of the display part 302 and for adjustability, as will be described further below. It is to be appreciated that small(er) versions may limit the number of holes. These holes are used to accommodate various sized straps. It is also to be appreciated that other types of fastening devices may be incorporated into the attachable device 300, such as but not limited to, snaps, clips, hook & loop, a buckle, etc. to secure the attachable device to the object.

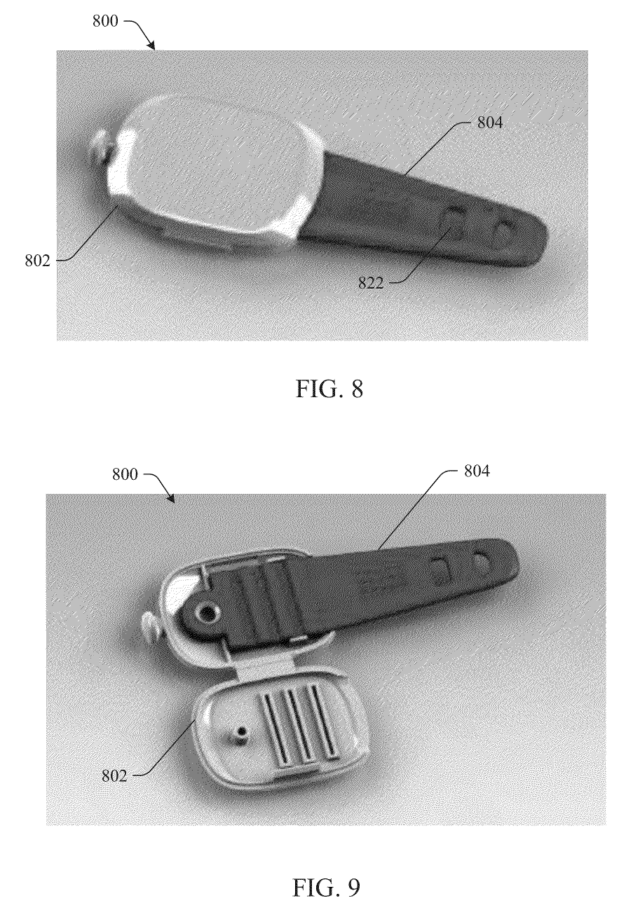

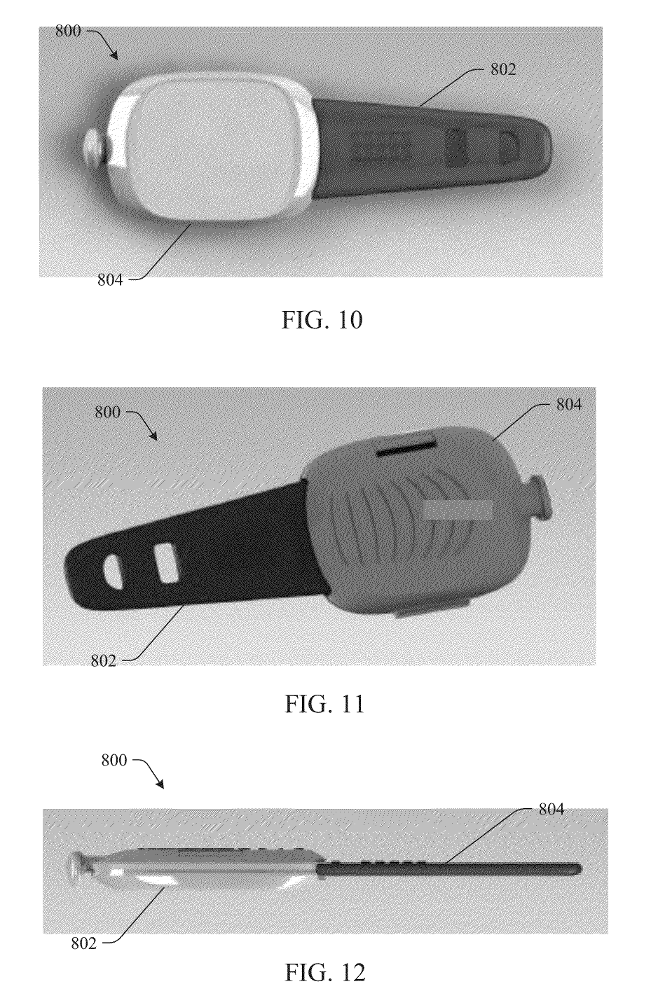

With reference now to FIGS. 8-12, FIGS. 8-12 illustrate an another example embodiment of an attachable device 800 that can be used as an awareness item that can be strapped to most any object mentioned above, in accordance with aspects of the innovation. The attachable device 800 includes a display part 802 and a mounting part 804.

The attachable device 800 shown in FIGS. 8-12 is similar to the attachable device 300 described above and illustrated in FIGS. 3-7, with the exception of the length of the mounting part 804. Specifically, the length of the mounting part 804 in this embodiment is shorter than a length of the mounting part 304 described above. As such, the number of holes 822 defined in the mounting part 804 is less than the number of holes 322 in the embodiment described above. While a specific embodiment is shown, alternative aspects can include other sizes, shapes, orientations, and configurations as desired or appropriate. For example, item 800 can be a smaller version (e.g., smaller face and strap) that will accommodate straps in the 1″ to 1-½″ range. Additionally, item 300 is a larger product (larger face and strap) that will accommodate larger straps in the 2″ 2-¾″ range (e.g., back pack and messenger straps).

As such, the length of the mounting part 804, 304 can vary depending on the strap size of the object mentioned above the attachable device will be displayed. It is to be appreciated, however, that the innovation described herein is not limited to the length of the mounting part. In other words, the length of the mounting part can be any desired length and can any number of holes to facilitate adjusting the attachable device to adapt to different sized objects or straps. For example, the attachable device can have one hole or multiple holes. Further, the hole(s) can be any shape, such as but not limited to circular, semi-circular, square, elongated, etc. In addition, the material can be elastic and can stretch to accommodate various size straps. All other aspects and functions of this embodiment are similar to the embodiment described above and, thus, will not be repeated.

FIGS. 13A-13F is an illustration of another embodiment of an attachable device 1300 in accordance with an aspect of the innovation. The attachable device 1300 includes a display part 1302 and a mounting part 1304.

The display part 1302 can be an integrated piece made from any suitable material, such as but not limited to, polyethylene, polypropylene, Acrylonitrile Butadiene Styrene (ABS), PA66 Nylon, etc. The display part 1302 is comprised of two separate parts, as opposed to a single part as described above. Specifically, the display part 1302 may include a separate first (or front) portion 1306 having a display area similar to the display area 308 described above and multiple projections (or tabs) 1308 extending from a rear of the first portion 1306, and a separate second (or rear) portion 1310 having multiple small apertures 1312. To assemble, the first portion 1306 is placed on one side of the mounting part 1304 and the second portion 1310 is placed on the other side of the mounting part 1304 such that the projections 1308 align with the small apertures 1312. The first portion 1306 and the second portion 1310 are pressed together to allow the projections 1308 to snap into or engage the apertures 1312.

The mounting part 1304, which serves as a strap, can be made from a suitable elastic material, such as but not limited to rubber, plastic, Styrene ethylene butadiene styrene (SEBS), tpe plastic, silicon, leather, etc., that allows the mounting part 1304 to stretch when the display device 1300 is used as intended. The mounting part 1304 may include an alignment projection 1314 that engages a large aperture 1316 defined in the second portion 1310 to facilitate alignment of the display part 1302 to the mounting part 1304. When assembled, a face 1318 on the alignment projection 1314 may be flush with a face 1320 on the second portion 1310. The alignment projection 1314 further provides friction or traction between the display part 1302 and the mounting part 1304 to secure the display part 1302 to the mounting part 1304.

A hole 1322 is defined in the mounting part 1304, whereby the hole 1322 engages a securing portion (projection) 1324 to facilitate the mounting of the attachable device 1300 to a strap or object mentioned above.

FIG. 14A illustrates another embodiment of an attachable device 1400A in accordance with an aspect of the innovation. The attachable device 1400A illustrated in FIG. 14A is similar to the attachable device 1300 illustrated in FIGS. 13A-13F in that the attachable device 1400A includes a two part display part 1402A and a mounting part 1404A. The mounting part 1404A in this embodiment, however, includes multiple holes 1422A that engage a securing portion (projection) 1424A that facilitates the mounting of the attachable device 1400A to an object mentioned above. The multiple holes 1422A allow the attachable device 1400A to adjust to different sized objects.

FIG. 14B illustrates another embodiment of an attachable device 1400B in accordance with an aspect of the innovation. The attachable device 1400B illustrated in FIG. 14B is similar to the attachable device 1300 illustrated in FIGS. 13A-13F in that the attachable device 1400B includes a two part display part 1402B and a mounting part 1404B. The mounting part 1404B in this embodiment, however, includes at least one elongated opening 1422B that engages a securing portion (projection) 1424B that facilitates the mounting of the attachable device 1400B to an object mentioned above.

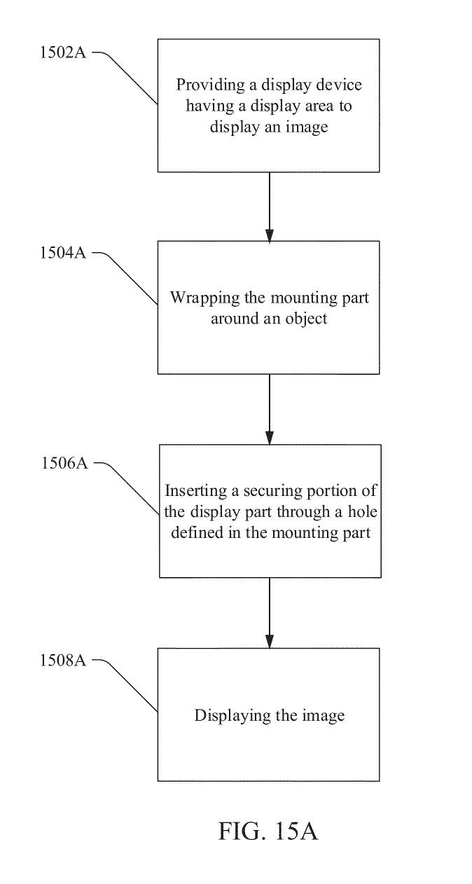

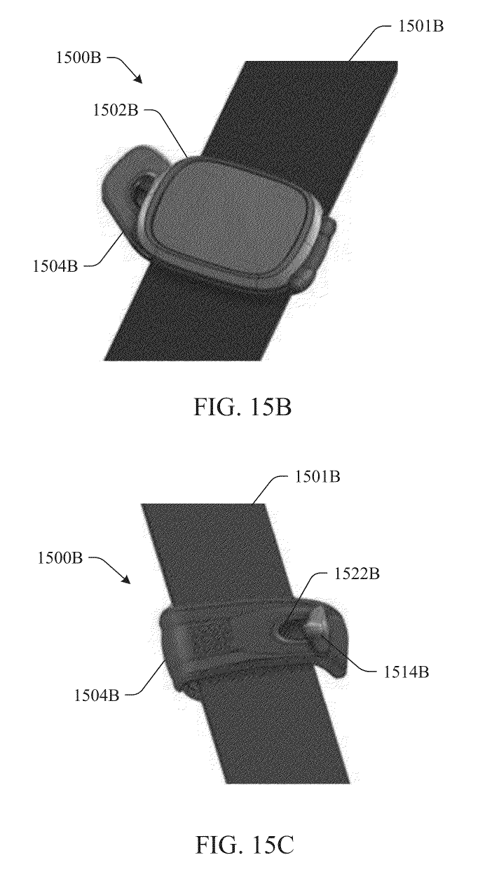

Referring to FIGS. 15A-15C, a method of displaying an awareness item 1500B on a strap 1501B or object mentioned above is described. At 1502A, the attachable device 1500B, which includes the display part 1502B and the mounting part 1504B, is provided, where the display part 1502B includes the display area to display an image. At 1504A, the user wraps the mounting part 1504B around the strap 1501B such that the display part is on a front of the strap 1501B such that the display area is facing outward to openly display the image. At 1506A, the securing portion 1514B is inserted through one of the holes 1522B defined in the mounting portion 1504B, thereby securing the attachable device 1500B to the strap 1501B. In alternative aspects, item 1514B can be designed more like a hook or the like to hold the strap. At 1508A, the image is displayed.

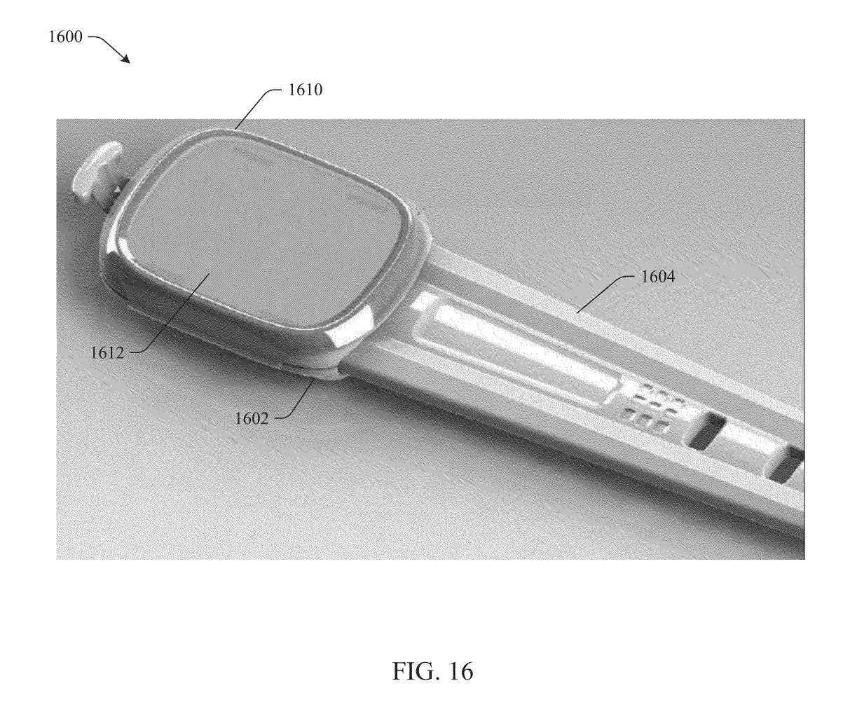

FIGS. 16-20 illustrate yet another embodiment of the attachable device 1600 in accordance with an aspect of the innovation. The attachable device 1600 is similar to the device described above in that the attachable device 1600 includes a display part 1602 and a mounting part 1604 whereby the display part 1602 receives a portion of the mounting part 1604, thus, like parts will not be repeated.

The attachable device 1600 in this embodiment further includes a cover (dome) 1610 that attaches to the display part 1602. The cover 1610 includes a face 1612 where a user can either place a sticker, decal, etc. on the face 1612 or simply slide an image printed on a piece of paper or similar medium onto the face 1612 to personalize the attachable device 1600. For example, the user can purchase stickers at the same time when purchasing the attachable device 1600 or download and print the stickers. Further, stickers or decals can be created with a custom paper punch where the punch has a similar shape to the display part.

In addition, the face 1612 may be transparent (clear or colored) to allow the user to view the display area of the display part 1602. For example, a user can personalize the device by placing an insert on the display part 1602 and attach the cover 1610 to the display part 1602 whereby the insert can be viewed through the transparent face 1612. For example, a user can insert a picture, emblem, logo, etc. on the display part 1602 to personalize the attachable device 1600. A user can further personalize the attachable device 1600 by having their picture taken with a character from a theme park, an animal at a zoo, or a thrill ride at an amusement park, etc. In addition, the face 1612 may include magnification to magnify the display area of the display part 1602.

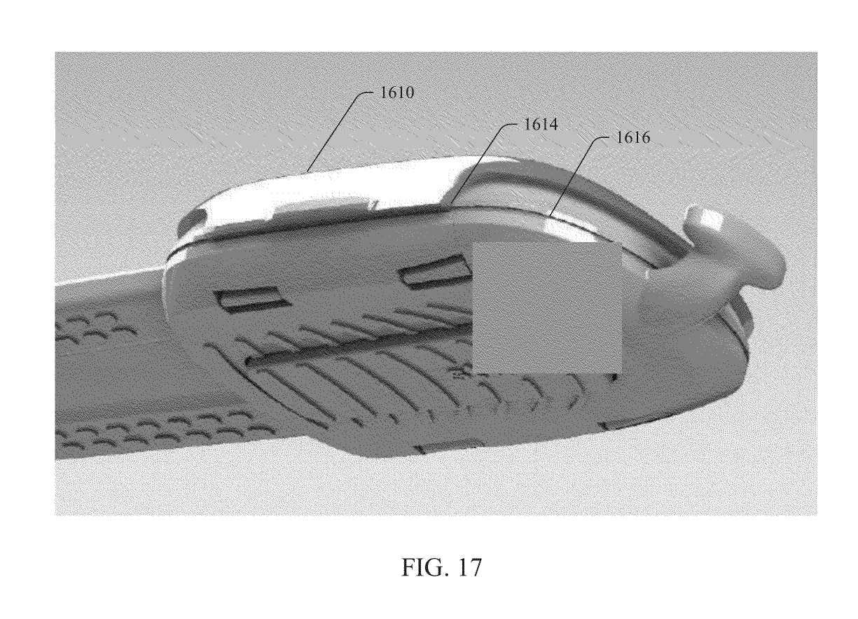

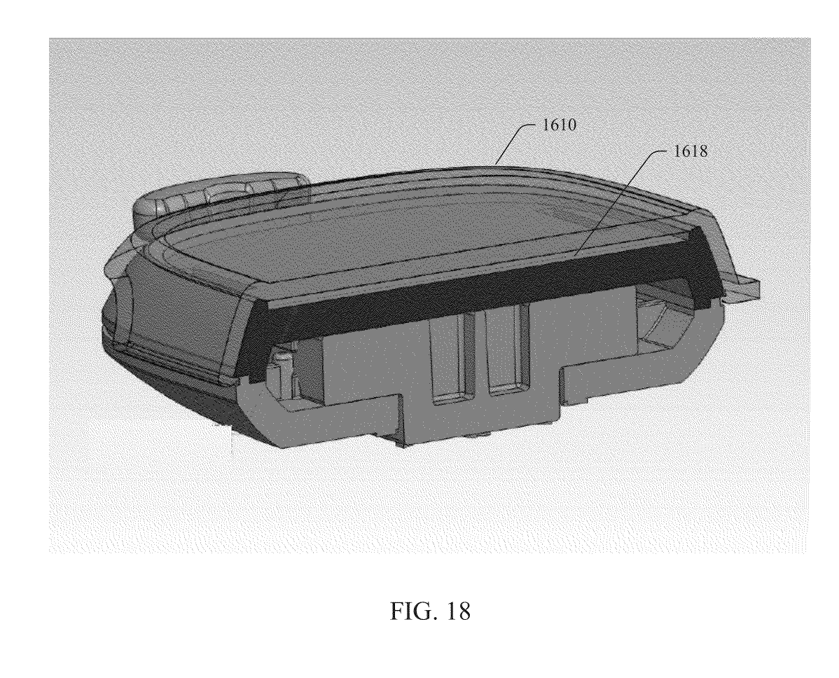

Referring to FIGS. 17 and 18, the cover 1610 includes an undercut portion 1614 that snaps into a groove 1616 on the display part 1602 to secure the cover 1614 onto the attachable device 1602. A gap 1618, see FIG. 18, facilitates insertion of the insert into the attachable device 1600. In another aspect the gap 1618 may be adapted to receive multiple inserts.

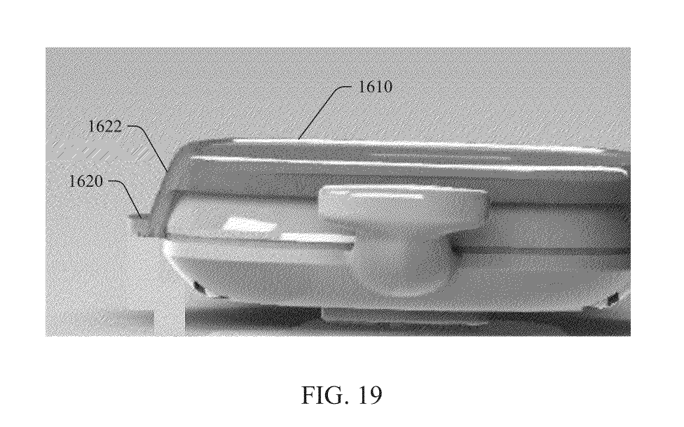

Referring to FIG. 19, the cover 1610 further includes a tab 1620 situated on one or both sides 1622 of the cover 1610. The tab 1620 facilitates attachment and removal of the cover 1610 to and from the attachable device 1600.

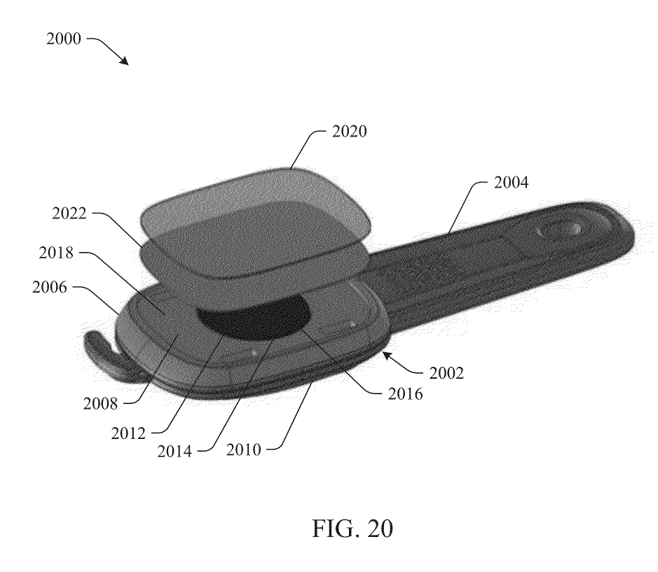

FIG. 20 illustrates still yet another embodiment of an attachable device 2000 in accordance with an aspect of the innovation. The embodiment illustrated in FIG. 20 has similar features to the embodiments described above and, thus, a detailed description of the similar features will not be repeated. The attachable device 2000 includes a display part 2002 and a mounting part 2004. The mounting part 2004 is similar to those described above and, thus, the details thereof will not be repeated. The display part 2002 includes a first (front) portion 2006 having a display area 2008, and a second (back) portion 2010. The display part 2002 in this embodiment may be a single piece as illustrated in FIGS. 3-12 or a two piece part as illustrated in FIGS. 13A-13F.

A magnet 2012 is disposed in an opening 2014 defined in the display area 2008 such that a top 2016 of the magnet 2012 is flush with a top surface 2018 of the display area 2008. The attachable device 2000 further includes a removable-transparent cover or dome 2020 made from a material, such as but not limited to a metal, adapted to be magnetically attracted to the magnet 2012.

The above configuration facilitates inserting, removing, replacing, and securing an insert 2022 containing an image to the attachable device 2000. In other words, the insert 2022 is placed on the display area 2008 and the magnetic cover 2020 is then placed on the insert 2022. The magnetic cover 2020 magnetically adheres to the magnet 2012 to thereby secure the insert 2022 to the display part 2002. If the user wishes to replace the insert 2022, the user simply removes the cover 2020 and the insert 2022 and places another insert 2022 containing a different image on the display area 2008. Thus, this configuration facilities the interchangeability of images.

In an alternate embodiment, the insert 2022 may be magnetized or may include a magnet to secure the insert 2022 to the display area 2008. In addition, the cover 2020 can also be magnetized or contain a magnet or can be adapted to snap, slide, etc. into fasteners, such as but not limited, rails, clips, etc. on the display area 2008.

It is to be appreciated, however, other means of removably attaching the cover to the first portion may be provided to facilitate the interchangeability of images. For example, first portion 2006 of the display part 2002 may include clips or rails to allow the cover to slidably attach to the first portion 2006.

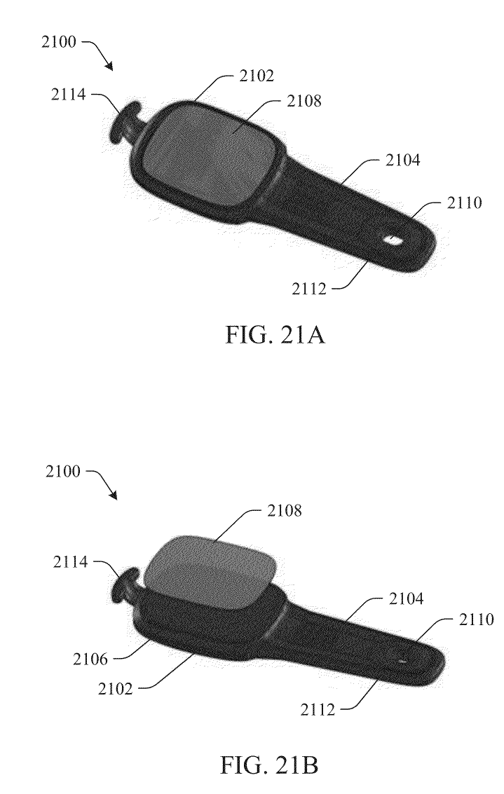

FIGS. 21A-21B illustrate yet another embodiment of an attachable device 2100 in accordance with an aspect of the innovation. The attachable device 2100 in this embodiment combines a display part 2102 and a mounting part 2104 into a single integrated piece. As in the embodiments above, the attachable device 2100 in this embodiment can be made from a suitable elastic material, such as but not limited to rubber, plastic, styrene ethylene butadiene styrene (SEBS), tpe plastic, silicon, leather, etc., that allows the mounting part 304 to stretch when the display device 300 is used as intended.

The display part 2102 includes a display area 2106 for the attachment of an image 2108 as described herein. The image 2108 may be attached to the display area 2106 in any fashion as described herein.

A hole 2110 is defined in a lower portion 2112 of the mounting part 2104. When the attachable device 2100 is displayed on a strap or the like, a securing portion (projection) 2114 that extends from the display part 2102 engages the hole 2110 to facilitate the attachment of the attachable device 2100 to an object as mentioned above.

All other aspects of the embodiment illustrated in FIGS. 21A and 21B are similar to those described above and will not be repeated.

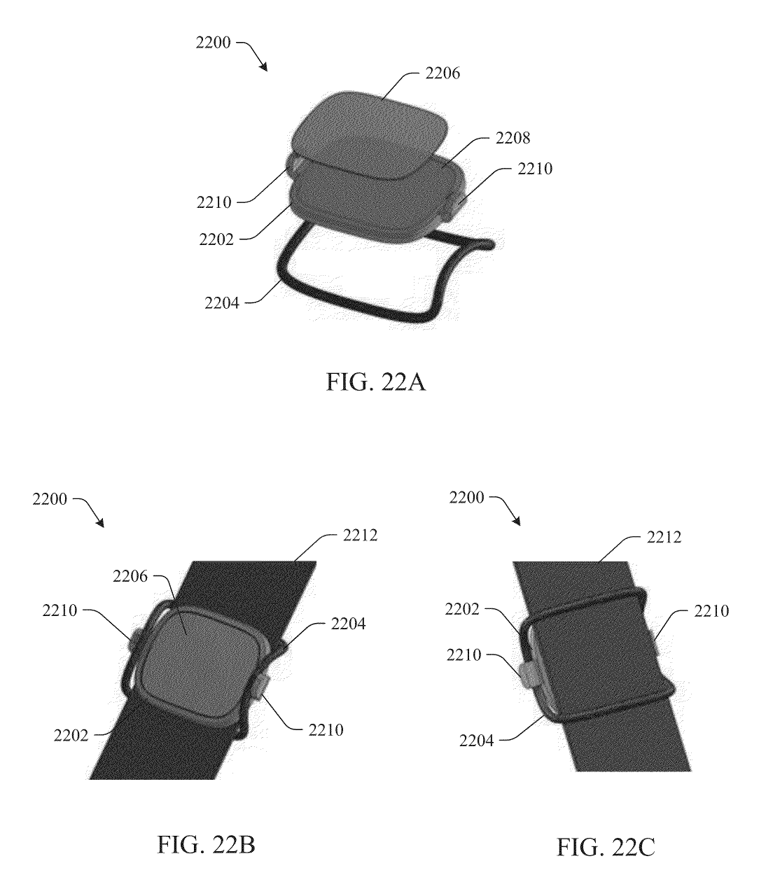

FIGS. 22A-22C illustrate another embodiment of an attachable device 2200 in accordance with an aspect of the innovation. The attachable device 2200 includes a display part 2202, a fastening (mounting) part 2204, and a cover or dome 2206.

The display part 2202 includes a display area 2208 adapted to receive an image by any means as described herein. The display part 2202 is a single integrated piece that further includes ears 2210 for the attachment of the fastening device 2208, described below.

The fastening part 2204 may be made from an elastic material and removably attaches the display part 2202 to an object or a strap 2212 on most any object (e.g. briefcase, purse, backpack, tote bag, laptop bag, duffle bag, messenger bag, beach bag, golf bag, lunch bag, equipment bag, camera bag, suitcase, lanyards, etc.) in accordance with aspects of the innovation. For example, as illustrated in FIGS. 22B-22C, the fastening part 2204 wraps around a back of the strap 2212 and extends around to a front of the strap 2212 and wraps around each ear 2210 on the display part 2202, thereby attaching the display part 2202 to the strap 2212.

The dome 2206 may be made from any transparent material, such as but not limited to, urethane. The dome 2206 attaches to the display part 2202 once the image is in place by any means as described herein. In another embodiment, in lieu of the image being placed directly on the display area 2208, the dome 2206 may include a digital print sticker, decal, etc. In addition, the dome 2206 may be transparent and removable to facilitate the interchangeability of the image.

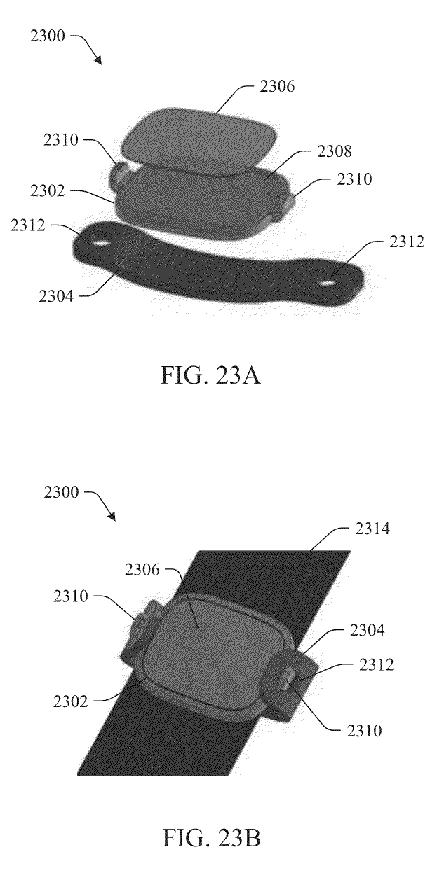

FIGS. 23A-23B illustrate another embodiment of an attachable device 2300 in accordance with an aspect of the innovation. The attachable device 2300 is similar to the attachable device 2200 illustrated in FIGS. 22A-22C in that the attachable device 2300 includes an integrated display part 2302 with a display area 2308 and ears 2310, a fastening (mounting) part 2304, and, a cover or dome 2306. Thus like features will not be repeated.

The fastening part 2304, however, is rectangular in shape and includes an aperture 2212 defined at each end. The fastening part 2304 attaches the display part 2302 to a strap 2214 or object similarly to the embodiment illustrated in FIGS. 22A-22C. In this embodiment, however, the ears 2310 engage the apertures 2212, see FIG. 23B, to thereby attach the display part 2302 to the strap 2214.

In another embodiment, the attachable device may include an optional clip. The clip may be mounted on the back of the display part or on the back of the mounting part. Thus, as an alternative, the attachable device can be clipped to a belt, strap, pocket, etc. In yet another embodiment, the attachable device may include two parts that clips around a belt, strap, etc. Thus, the attachable device can include any type of mechanical attaching means to attach the attachable device to an object mentioned above. Thus, the attaching means (e.g. strap, clip, etc.) disclosed herein are for illustrative purposes only and are not intended to limit the scope of the innovation.

The attachable device described herein has many applications that are not disclosed herein. For example, the device can be used to wrap around other objects, such as but not limited to, shoelaces, shirt sleeves, cords, necklace, belts, ropes, wrist, etc. In other words, the attachable device can be used on an unlimited number of applications. Thus, the applications disclosed herein are for illustrative purposes only and are not intended to limit the scope of the innovation.

In still yet another application, the attachable device can be made in any color or colors as desired. For example, the display part and the mounting part can be the same color or different colors to represent school colors, team color, company colors, etc. Still further, in another embodiment both the display part and/or the mounting part can display multiple colors. In other aspects, patterns (e.g., circles, squares, tie-dye, etc.) could be created on the attachable device. As well, other materials, single materials, fabric, Velcro, single piece of silicone that has a chamber to insert a puck like image, etc. can be employed to accomplish features, functions and benefits of the innovation. In other embodiments, the attachable device can contain glitter, be made from a material that glows, can include scents, can change color based on temperature, or change color based on mood. These alternatives are to be included within the scope of the specification and claims appended hereto.

In still yet another embodiment, the display area of the display part can be transparent. Thus, a picture can be disposed inside the display part so that it can be seen through the transparent display area that may or may not include magnification. Thus, the attachable device can serve a locket.

In alternate embodiment, the attachable device disclosed herein can be configured as a radio frequency identification (RFID) tag. The RFID tag can electronically store information that can be read by other devices. Thus, the attachable device can be used as an electronic identification tag or be used for tracking purposes.

In yet another alternate embodiment, the attachable device disclosed herein can be configured as a near field communication (NFC) device. The NFC device can establish communication with similar devices including RFID tags when in close proximity. Thus, the attachable device can exchange data and other information with the other similar devices.

In yet another embodiment, the attachable device may include lights to light the face and/or the device. The lights may strobe, flicker, change color, etc.

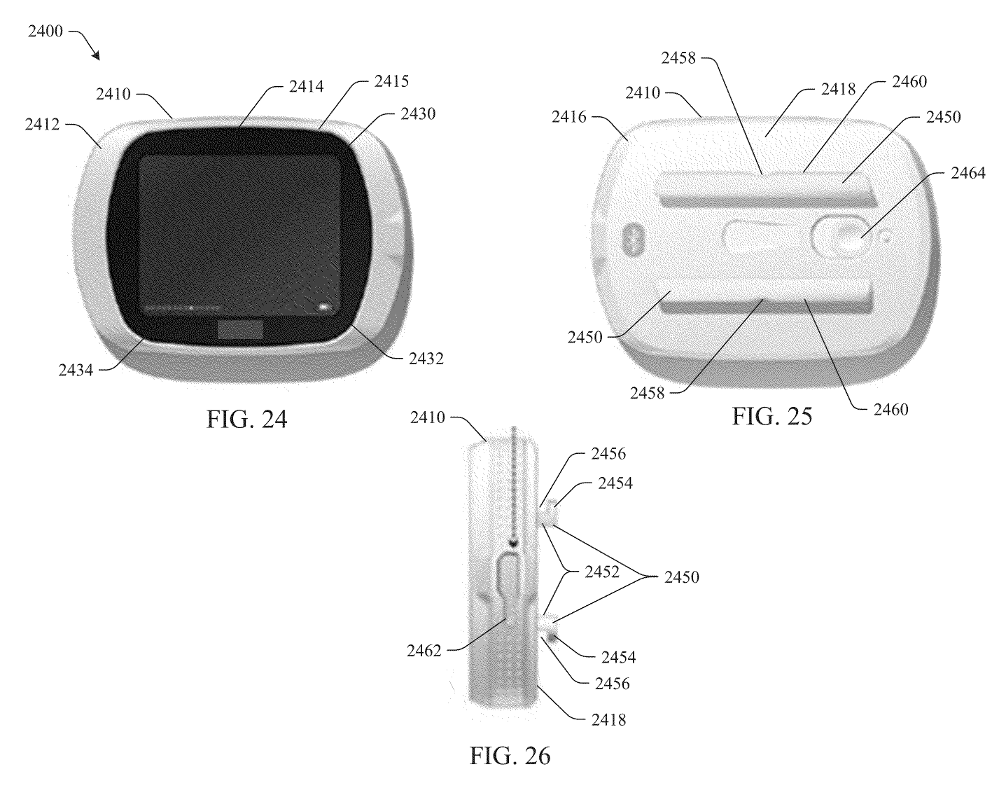

FIGS. 24-34 illustrate yet another example embodiment of a display device 2400 for presenting content (e.g., imagery, videos, audio, etc.) in accordance with an aspect of the innovation. FIGS. 24-26, illustrate a front, rear and a side view respectively of the content presentation display device 2400, which includes a housing 2410, a display 2430, and a mounting device including a pair of mounting rails 2450 in accordance with an aspect of the innovation. The display device 2400 can be an integrated piece made from any suitable material, such as but not limited to, polyethylene, polypropylene, Acrylonitrile Butadiene Styrene (ABS), PA66 Nylon, metal, etc.

Still referring to FIGS. 24-26, in one embodiment, the housing 2410 may include a first (front) housing portion 2412 having a front surface 2414 including an opening 2415 defined therein and a second (rear) housing portion 2416 having a rear surface 2418 attached to each other (e.g., snap) as disclosed above. In another embodiment, the first and second housing portions 2412, 2416 may be integrated thus, forming a single unit. In other embodiments, the housing 2410 may be waterproof, weatherproof, or otherwise protect electronic components from the elements.

Referring back to FIG. 24, the display 2430 is disposed in the first housing portion 2412 of the housing 2410 and may be a graphics display, such as but not limited to, a liquid crystal display (LCD), a touch screen or any other type of graphics display with or without touch screen functionality. In addition, the display 2430 may be color, black and white, etc. The display may display system or operational status icons 2432 and/or text 2434 to display content items, such as but not limited to, informational data, system status icons, etc. The informational data may include data, such as but not limited to date, time, appointments, events, etc. The system/operational status icons may include icons such as but not limited to power level status, power connectivity, WiFi connectivity, communications (e.g., email, text, etc.) status, download/upload status, etc.

Each of the pair of mounting rails 2450 are attached to the rear surface 2418 of the housing 2410 and are substantially parallel to each other. Each rail 2450 includes a first rail part 2452 attached to the rear surface 2418 of the second portion 2416 of the housing 2412 and a second rail part 2454 attached to a top of the first rail part 2452. The first rail part 2452 extends away from the rear surface 2418 such that a face or surface of the first rail part 2452 is substantially perpendicular to the rear surface 2418 of the housing 2410.

The second rail part 2454 extends from a top of the first rail part 2452 substantially perpendicular to the first rail part 2452 such that a face or surface of the second rail part 2454 is essentially parallel to the rear surface 2418 of the housing 2410. In addition, the second rail parts 2454 extend in a direction away from the other. The configuration of the rail 2450 forms a channel 2456 between the rear surface of the housing 2410 and the rail 2450. A recess 2458 is provided on a distal edge 2460 on each second rail part 2454 and facilitates alignment of the display device 2400 when displayed, as will be described further below.

The mounting rails 2450 facilitate mounting or displaying the image display device on a strap, handle, a wrist, a belt, a pocket, attached to a surface, mounted on a free standing stand, etc. as will be described further below.

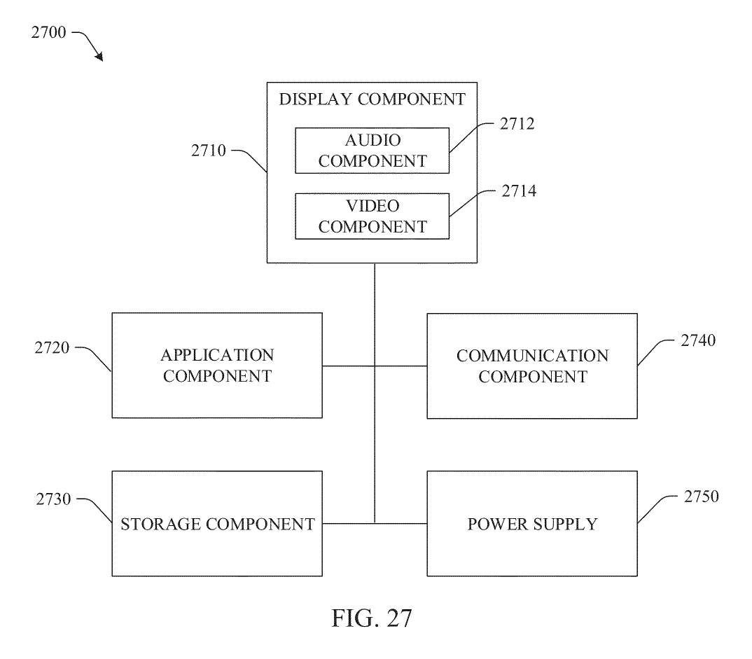

Referring to FIG. 27, the display device 2400 further includes a system 2700 for presenting the content that includes a display component 2710, an application component 2720, a storage component 2730, a communication component 2740, and a power supply 2750, all of which are disposed inside the housing 2430.

The display component 2710 may have touch screen functionality which would enable a user to interface with the application component 2720, communication component 2740, or other components within the system, for example. The display component 2710 may display content, such as but not limited to one or more images, one or more renderings (e.g., audio clip, video clip, etc.), one or more animations, logos, brand, or the like, for example. Respective images, renderings, animations, logos, etc. may be stored on the storage component 2730. The display component 2710 may display other content items, such as the day of the week, date, time, a calendar appointment, status icons (e.g., power supply level, etc.), etc.

The display component 2710 may display or render one or more images, logos, animations, renderings, etc. to promote brand awareness. For example, the display component 2710 may display an image of a mascot associated with a professional sports team where the image is stored on the storage component 2730 of the system. In other embodiments, the display component 2710 may display an image which is streamed such that the image is not locally stored on the system 2700 or the storage component 2730, for example. Examples of content which may be displayed by the display component 2710, stored on the storage component 2730, or streamed from other devices may include a brand name, a promotion, a campaign, a logo, an individual, mascot, an allegiance, a school name, a team name, a character (e.g., cartoon, television, etc.), an ID or name tag, a locket to hold a picture, a company, a product, a service, a cause, an activity, a destination/stadium, a person, an actor, an actress, an artist, an athlete, a singer, a movie, a television show, a slogan, etc. Images may have, include, or be associated with a name, sign, symbol, product, service, slogan, color, a logo (e.g., team logo, company logo/trademark, etc.), etc.

In one or more embodiments, the display component 2710 may include an audio component 2712 for rendering audio stored on the storage component 2730 or may be streamed from an external device or source through the audio component 2712. Audio or audio clips rendered by the audio component 2712 may or may not be associated with images or other renderings displayed by the display component 2710. For example, if the display component 2710 is displaying a slideshow of images or logos, an audio clip being played may include background music. In other examples, the audio clip may be a fight song for a team and the display component 2710 may display a logo for or associated with that team, for example. In one or more embodiments, the audio component may include one or more speakers integrated into the system 2700 for presenting content and/or a microphone for recording content onto the storage component 2730.

The display component 2710 may further include a video component 2714 for rendering video. The videos may be stored on the storage component 2730 or may be streamed from an external device or source through the video component 2714. The videos may contain content, such as but not limited to advertisements, movies, TV series, recorded videos, music videos, etc.

The application component 2720 may manage one or more images, content, or content items or how they are displayed. For example, the application component 2720 may enable a user to display a slideshow, select which images or logos are part of a slideshow, to scroll through different images or logos, when to display a logo, setup a display schedule, etc. The application component 2720 may be remotely managed via a connection, such as a Bluetooth connection, a wireless connection, a communication channel, etc. For example, a user may download an application on his or her mobile device from an app store which allows the user to utilize his or her mobile device to manage content on the storage component 2730 of the system 2700. In one or more embodiments, the user may add, delete, remove, change, or manage content utilizing the application on his or her mobile device to interface with the system 2700.

For example, the application on the mobile device may allow a user to move content from the mobile device to the system 2700 or from a play store or digital store to the system 2700. Here, in this example, content, images, content items, logos, etc. may be uploaded, downloaded, or communicated across a wireless channel, a Bluetooth channel, etc. The application component 2720 may enable media to be controlled by the application on the mobile device in this way. Further, other remote functionality may be possible with the mobile device. For example, the volume buttons of a mobile device may be utilized to scroll through images displayed by the display component 2710 of the system 2700 in a remote manner. If a display component 2710 of a system 2700 does not have touch screen functionality, the application component 2720 may enable a user to utilize the touch screen of his or her smart phone or mobile device to provide inputs to the system 2700 for presenting content. In other words, the touch screen of the mobile device may be utilized to scroll through images or logos displayed by the display component 2700 (e.g., swipe right or left to scroll).

The application component 2720 may enable the system 2700 to operate in different modes, such as streaming mode, slideshow mode, static image mode, flashlight mode, stream video, access media of a mobile device or content of a mobile device, etc. In one or more embodiments, the application component 2720 enables the system 2700 to receive/give commands, such as Bluetooth commands from a master device. In other words, the application component 2720 enables the system 2700 to act as either a master or slave in a master-slave relationship with other devices.

The storage component 2730 may store different types of media, such as images, logos, audio clips, photo, video, animations, etc. The storage component 2730 may utilize flash memory, a hard drive, micro hard drive, solid state drives, or other types of storage technology to house a variety of content for the display component 2710 to present, render, or display.

The communication component 2740 may enable connectivity from the system 2700 to one or more external devices or sources to load one or more of the images to the storage component 2730. For example, external devices may include, a mobile phone, a tablet, a computer, etc. and the external sources may include a cloud, the internet, etc. The communication the communication component 2740 may receive one or more images from the one or more external devices/sources via a wireless channel, a Bluetooth channel, a USB connection, etc. Further, the communication component 2740 may transmit one or more of the images to the storage component 2730 for local storage, according to one or more embodiments.

The communication component 2740 may include RFID technology to track proximity to objects or utilize GPS technology to track a location of the system 2700. To this end, the system 2700 for presenting content may display, render, or present one or more images or one or more content items based on the location of the system 2700 or the proximity of the system 2700 to real world objects, such as kids, people, etc. In this way, content items or images (e.g., images, videos, advertisements, coupons, color, music, audio, etc.) may be presented by the display component 2710 based on proximity or location of the system 2700.

The power supply 2750 may be a battery, rechargeable battery, etc. In one or more embodiments, the display device 2400 may include a universal serial bus (USB) port 2462 (see FIG. 26) and as such, the power supply 2750 may be recharged utilizing a cord charger, such as a micro universal serial cable which enables the system 2700 to be charged when connected to a computer, USB wall charger adapter, tablet, laptop, etc. In another embodiment, the power supply may be recharged via solar energy. In addition, the display device 2400 may include an ON/OFF switch 2464 that may be located anywhere on the display device 2400. In the example embodiment illustrated in FIG. 25, the ON/OFF switch is located on the rear surface 2418 of the housing 2410.

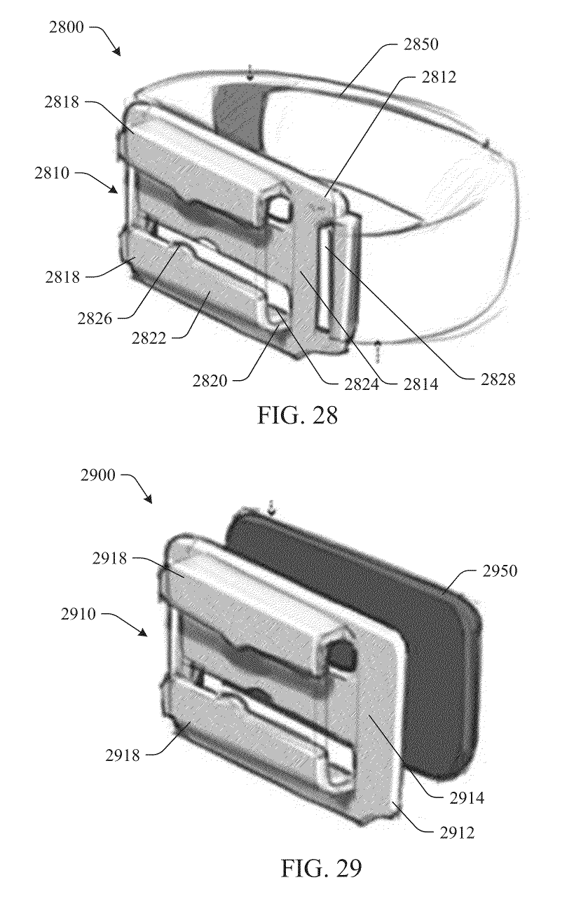

FIGS. 28-31, illustrate different example embodiments of attachment assemblies for mounting or displaying the display device 2400 in accordance with an aspect of the innovation. The attachment assemblies in conjunction with the mounting rails 2450 facilitate mounting or displaying the image display device on a strap, handle, a wrist, a belt, a pocket, attached to a surface, mounted on a free standing stand, etc.

FIG. 28 illustrates one example embodiment of an attachment assembly 2800 in accordance with an aspect of the innovation. The attachment assembly 2800 includes a connecting device 2810 and an attachment device 2850. The connecting device 2810 is configured to engage or mate with the pair of rails 2450 described above and provide a connection between the display device 2400 and the attachment device 2850. In one example embodiment, the connecting device 2810 may be made from a material, such as but not limited to, rubber, plastic, Styrene ethylene butadiene styrene (SEBS), tpe plastic, silicon, leather, metal, etc.

The connecting device 2810 includes a plate portion 2812 having a first (front) side 2814 and a second (rear) side not shown, but opposite that of the first side 2814, and a pair of connecting rails 2818. Each of the pair of connecting rails 2818 are attached to the first side 2814 of the plate 2812 and are substantially parallel to each other. Each connecting rail 2818 includes a first connecting rail part 2820 attached to the first side 2812 and a second connecting rail part 2822 attached to a top of the first connecting rail part 2820. The first connecting rail part 2820 extends away from the first side 2814 of the plate 2812 such that a face or surface of the first connecting rail part 2820 is a substantially perpendicular to the first side 2814 of the plate 2812.

The second connecting rail part 2822 extends from a top of the first connecting rail part 2820 substantially perpendicular to the first connecting rail part 2820 such that a face or surface of the second connecting rail part 2822 is essentially parallel to the first side 2814 of the plate 2812. In addition, the second connecting rail parts 2822 extend in a direction toward each the other, which is opposite to that of the configuration of the rails 2450 described above. The configuration of the connecting rails 2818 forms a connecting channel 2824 between the first side 2814 of the plate 2812 and the connecting rails 2818. A bump or projection 2826 is provided on a distal edge 2828 on each second connecting rail part 2822 such that the bump 2826 aligns with the recess 2458 on the mounting rails 2450 described above when the image display device is attached to the connecting device 2810.

In this example embodiment, the connecting device 2810 may further include a first set of slots 2828, one each defined in each end of the plate 2812. The slots 2828 are substantially parallel to each other and are configured to receive the attachment device 2850. In this example embodiment, the attachment device 2850 is a strap or wrist band that can be attached to a wrist or any other object, such as but not limited to, a backpack strap, purse strap, brief case strap, computer case strap, handle, etc. The strap 2850 threads through each slot 2828 and wraps around the desired object and attaches to itself via a fastening device, such as but not limited to Velcro, snaps, buckles, clips, etc. A second set of slots 2830 that are substantially perpendicular to the first set of slots 2828 are provided that may be used to attach a strap in a perpendicular manner to the strap illustrated in FIG. 28. In one example embodiment, the strap 2850 may be made from a flexible material, such as but not limited to, rubber, plastic, Styrene ethylene butadiene styrene (SEBS), tpe plastic, silicon, leather, etc., that allows the strap 2850 to stretch. In another embodiment, the strap 2850 may be made from a more rigid material, such as but not limited to metal.

FIG. 29 illustrates another example embodiment of an attachment assembly 2900 in accordance with an aspect of the innovation. The attachment assembly 2900 includes a connecting device 2910 and an attachment device 2950. The connecting device 2950 is configured to engage or mate with the pair of rails 2450 described above and provide a connection between the display device 2400 and the attachment device 2950. The connecting device 2910 is similar to the connecting device 2810 described above and illustrated in FIG. 28 with the exception that the connecting device 2910 of FIG. 29 does not include the first set of slots 2828. All other features of the connecting device 2910 are the same and will not be repeated.

In this embodiment, the attachment device 2950 is a fastening device, such as but not limited to double sided tape, Velcro, a magnet, etc. The fastening device is configured to attach and display the display device 2400 on a surface, such as but not limited to a locker, desk, cabinet, etc. Thus, one side of the fastening device 2950 attaches to the second side (rear) of the connecting device 2910 and the opposite side attaches to the object where the user wishes to display the image display device. In a modified version, the image display device 2900 may be made of metal and the attachment device 2950 may be magnet that attaches to a metal object. In still yet another modified version, all or a portion of (e.g., rear surface 2418) of the housing 2410 of the display device 2400 may itself be a magnet that can therefore, be directly mounted to a metallic surface.

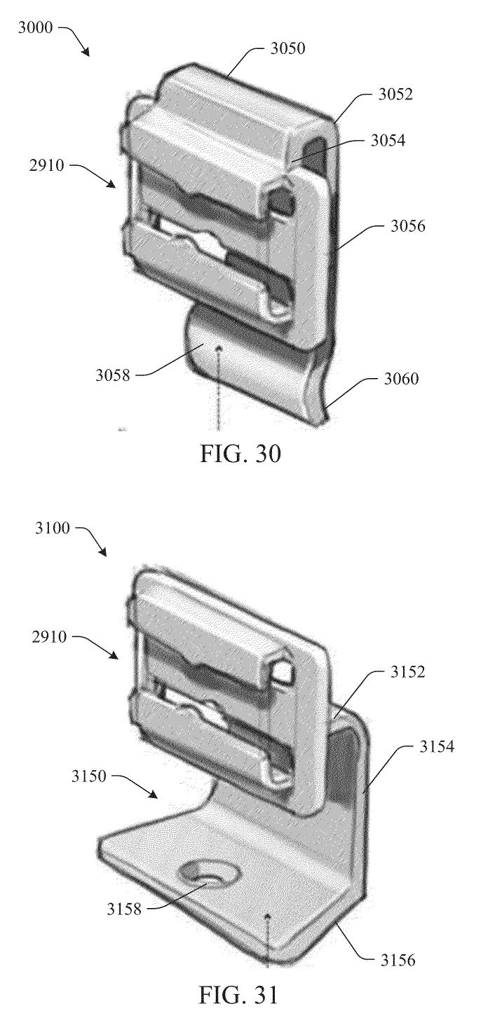

FIG. 30 illustrates another example embodiment of an attachment assembly 3000 in accordance with an aspect of the innovation. The attachment assembly 3000 includes the connecting device 2910 described above and illustrated in FIGS. 28 and 29 and an attachment device 3050. The attachment device 3050 is a clip type fastener configured to clip to an object, such as but no limited to a strap as disclosed herein, a pocket, a belt, etc. The attachment device 3050 attaches to a top of the connecting device 2910 either integrally or by a snap feature, slide feature, etc. The attachment device 3050 includes a U-shaped end 3052 where a first portion 3054 attaches to the top of the connecting device 2910, as described above.

A second portion 3056 extends along and past the second side of the connecting device 2910 and includes a curved portion 3058 at a distal end 3060 of the second portion 3056. To display the display device 2400 the user slides the object (e.g., strap, belt, etc.) between the second side of the connecting device 2910 and the second portion 3056 of the attachment device 3050. The curved portion 3058 facilitates securing the image display device to the object.

FIG. 31 illustrates yet another example embodiment of an attachment assembly 3100 in accordance with an aspect of the innovation. The attachment assembly 3100 includes the connecting device 2910 described above and illustrated in FIGS. 28 and 29 and an attachment device 3150. The attachment device 3150 is a stand type display that is configured to rest on a surface, (e.g., table top, desk top, etc.).

The attachment device 3150 has a U-shaped configuration that includes a first (top) portion 3152 that attaches to the second side of the connecting device 2910, a second (middle) portion 3154, and a third (bottom) portion 3156. The second portion 3154 connects the first and third portions 3152, 3156 to form the U-shaped configuration, as illustrated in FIG. 31. A mounting hole 3158 is defined in the third portion 3156 that receives a fastening device (e.g., nail, screw, etc.) to thereby secure the attachment device 3150 and ultimately, the display device 2400 to the surface.

To connect the display device 2400 to the connecting device 2810, 2910, the user slides the display device 2400 and the connecting device 2810, 2910 together such that the first rail part 2454 on the display device 2400 engages the channel 2854 on the connecting device 2810, 2910 and the second connecting rail part 2822 on the connecting device 2810, 2910 engages the channel 2456 on the display device 2400. The display device 2400 and the connecting device are slid together until the projection (bump) 2826 is aligned with and engages the recess 2458.

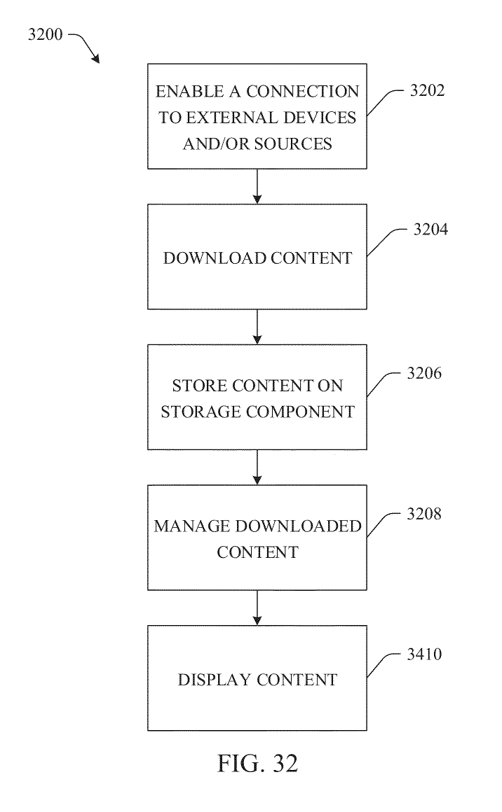

FIG. 32 is an illustration of an example flow diagram of a method 3200 for presenting content, according to one or more embodiments. At 3202, the communication component 2740 enables a connection to external devices and/or sources as described herein to allow the downloading of content (3204). At 3206, the storage component 2730 stores the downloaded content. At 3208, the application component 2720 manages the downloaded content as described herein. At 3210, the display component displays or renders the content.

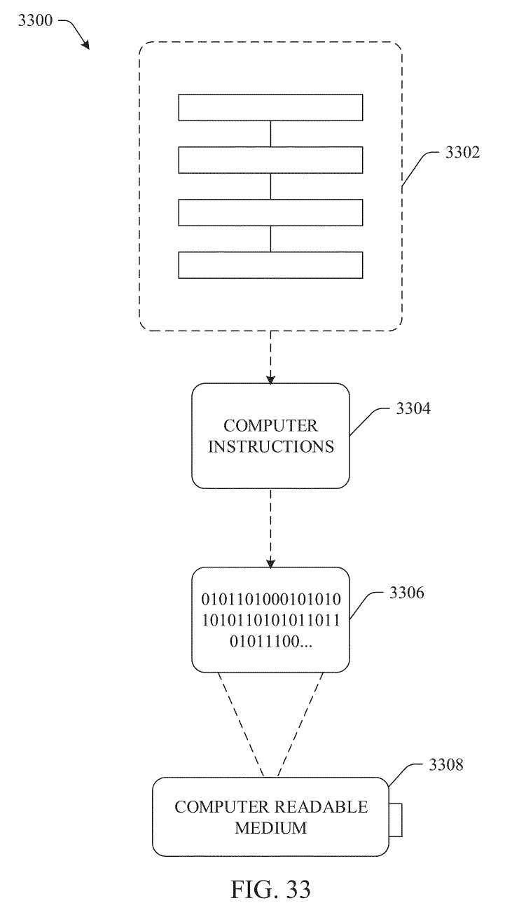

Still another embodiment involves a computer-readable medium including processor-executable instructions configured to implement one or more embodiments of the techniques presented herein. An embodiment of a computer-readable medium or a computer-readable device devised in these ways is illustrated in FIG. 33, wherein an implementation 3300 includes a computer-readable medium 3308, such as a CD-R, DVD-R, flash drive, a platter of a hard disk drive, etc., on which is encoded computer-readable data 3306. This computer-readable data 3306, such as binary data including a plurality of zero's and one's as shown in 3306, in turn includes a set of computer instructions 3304 configured to operate according to one or more of the principles set forth herein. In one such embodiment 3300, the processor-executable computer instructions 3304 may be configured to perform a method 3302, such as the method 3300 of FIG. 33. In another embodiment, the processor-executable instructions 3304 may be configured to implement a system, such as the system 2700 of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

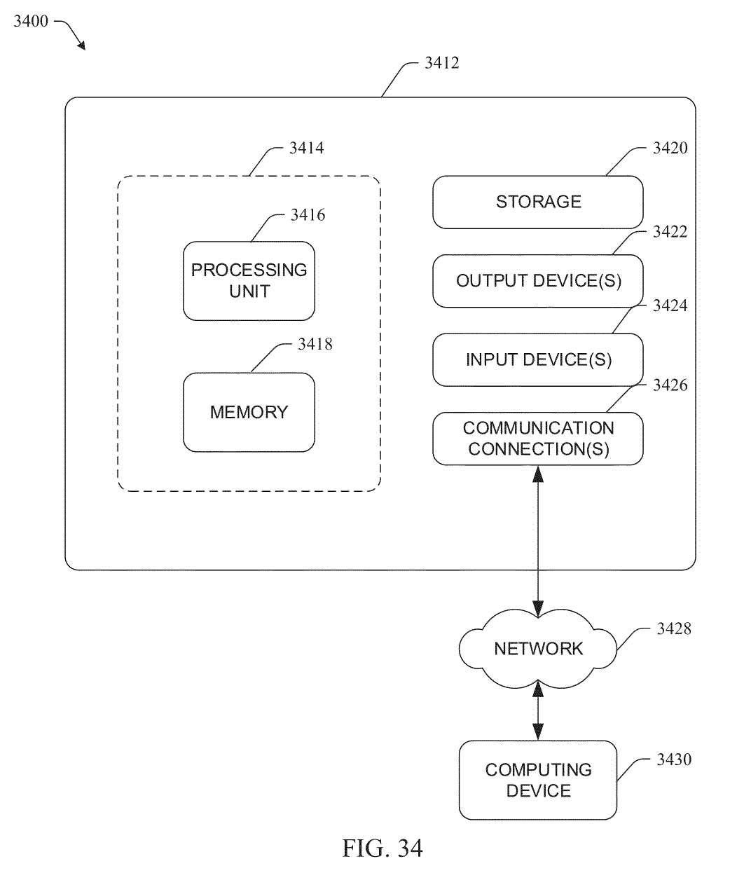

FIG. 34 and the following discussion provide a description of a suitable computing environment to implement embodiments of one or more of the provisions set forth herein. The operating environment of FIG. 34 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, embodiments are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 34 illustrates a system 3400 including a computing device 3412 configured to implement one or more embodiments provided herein. In one configuration, computing device 3412 includes at least one processing unit 3416 and memory 3418. Depending on the exact configuration and type of computing device, memory 3418 may be volatile, such as RAM, non-volatile, such as ROM, flash memory, etc., or a combination of the two. This configuration is illustrated in FIG. 6 by dashed line 3414.

In other embodiments, device 3412 includes additional features or functionality. For example, device 3412 may include additional storage such as removable storage or non-removable storage, including, but not limited to, magnetic storage, optical storage, etc. Such additional storage is illustrated in FIG. 6 by storage 3420. In one or more embodiments, computer readable instructions to implement one or more embodiments provided herein are in storage 3420. Storage 3420 may store other computer readable instructions to implement an operating system, an application program, etc. Computer readable instructions may be loaded in memory 3418 for execution by processing unit 3416, for example.

The term “computer readable media” as used herein includes computer storage media. Computer storage media includes volatile and nonvolatile, removable and non-removable media implemented in any method or technology for storage of information such as computer readable instructions or other data. Memory 3418 and storage 3420 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by device 3412. Any such computer storage media is part of device 3412.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 3412 includes input device(s) 3424 such as keyboard, mouse, pen, voice input device, touch input device, infrared cameras, video input devices, or any other input device. Output device(s) 3422 such as one or more displays, speakers, printers, or any other output device may be included with device 3412. Input device(s) 3424 and output device(s) 3422 may be connected to device 3412 via a wired connection, wireless connection, or any combination thereof. In one or more embodiments, an input device or an output device from another computing device may be used as input device(s) 3424 or output device(s) 3422 for computing device 3412. Device 3412 may include communication connection(s) 3426 to facilitate communications with one or more other devices.

Although the subject matter has been described in language specific to structural features or methodological acts, it is to be understood that the subject matter of the appended claims is not necessarily limited to the specific features or acts described above. Rather, the specific features and acts described above are disclosed as example embodiments.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system for presenting content comprising:
a display component that displays content and/or content items;
an application component that manages the content and/or content items displayed by the display component;
a storage component that stores the content and the content items;
a communication component that enables connectivity to one or more external devices to upload/download the content and content items to/from the storage component; and
a power supply providing power to the system for displaying images.

2. The system of claim 1, wherein the content includes an image or a rendering.

3. The system of claim 2, wherein the rendering includes a video and/or audio clip.

4. The system of claim 1, wherein the content items include informational data and/or at least one system status icon.

5. The system of claim 1, wherein the display component is a liquid crystal display (LCD).

6. The system of claim 1 further comprising an audio component for presenting audio clips.

7. The system of claim 1 further comprising a video component for presenting videos.

8. The system of claim 7, wherein the video is streamed from an external device or is stored in the storage component.

9. The system of claim 1 further comprising a universal serial bus port that facilitates charging of the power supply.

10. A display device for presenting content comprising:
a housing having an opening defined in a front portion;
a display disposed in the opening and that presents content and/or content items;
a mounting device disposed on a rear surface of the housing;
a system for presenting content disposed inside the housing; and
an attachment assembly that attaches to the mounting device and to an object for the purpose of displaying the content.

11. The display device of claim 10, wherein the content includes audio and/or video clips.

12. The display device of claim 11, wherein the system includes a storage component and wherein the audio and/or video clips are streamed through an external device or are stored on the storage component and presented by the display.

13. The display device of claim 12, wherein the content items include informational data and/or status icons.

14. The display device of claim 10, wherein the mounting device includes a pair of rails mounted to the rear surface of the housing and wherein the pair of rails are substantially parallel to each other.

15. The display device of claim 14, wherein the attachment assembly includes a connecting device and an attachment device, wherein the connecting device includes a plate and a pair of connecting rails disposed on a first side of the plate that engage the pair of rails on the rear surface of the housing, and wherein the attachment device attaches to the plate thereby facilitating attachment of the display device to the object.

16. The display device of claim 15, wherein the attachment device is a strap.

17. A method of displaying content comprising:
connecting to an external device and/or source via a communication component;
downloading content from the external device and/or source;
storing the content on a storage component;
managing the content stored on the storage component; and
displaying the content on a display component.

18. The method of claim 17, wherein managing the content stored on the storage component includes:
operating the external device;
providing inputs to the display component; and
displaying content on the display component based on the inputs from the external device.

19. The method of claim 18, wherein the external device includes a mobile phone, a tablet, or a computer and the external sources include a storage cloud or an internet.

20. The method of claim 19, wherein the content includes audio and/or video clips.
